(19) United States
(12) Patent Application Publication
(10) Pub. No.: US 2026/0170110 A1
(43) Pub. Date: Jun. 18, 2026

(54) TOUCH SENSOR FOR USER AUTHENTICATION AND METHOD OF USING SAME

(71) Applicant: Microchip Touch Solutions Limited, Berkshire (GB)

(72) Inventor: Mohamed Gamal Ahmed Mohamed, Cambridgeshire (GB)

(21) Appl. No.: 19/420,389

(22) Filed: Dec. 15, 2025

Related U.S. Application Data
(60) Provisional application No. 63/734,607, filed on Dec. 16, 2024.

(51) Int. Cl. G06F 21/31

(52) U.S. Cl. CPC G06F 21/316

(57) ABSTRACT

A user authentication system is provided, which may include a plurality of touch sensors to detect a touch event and generate one or more touch signals corresponding to the touch event, and a controller to receive the one or more signals generated by the plurality of touch sensors and generate an authentication request signal in response to the one or more touch signals. One or more of the plurality of touch sensors may wirelessly transmit the authentication request signal to a user device and receive a wireless response signal from the user device. The controller may authenticate the user based on the wireless response signal from the user device.

### CROSS-REFERENCE TO RELATED APPLICATION

The present application claims priority from U.S. Provisional Patent Application No. 63/734,607 filed on Dec. 16, 2024, which is incorporated herein by reference in its entirety.

### TECHNICAL FIELD

The present disclosure relates generally to touch sensors, and more specifically to capacitive touch sensors that can be used for user authentication.

### SUMMARY

According to an aspect of one or more examples, there is provided user authentication system, which may include a plurality of touch sensors to detect a touch event and generate one or more touch signals corresponding to the touch event, and a controller to receive the one or more signals generated by the plurality of touch sensors and generate an authentication request signal in response to the one or more touch signals. One or more of the plurality of touch sensors may wirelessly transmit the authentication request signal to a user device and receive a wireless response signal from the user device. The controller may authenticate the user based on the wireless response signal from the user device.

The controller may scan the plurality of touch sensors to receive the one or more touch signals, and demodulate the one or more touch signals to extract data from the one or more touch signals. The controller may modulate data corresponding to the authentication request signal over a carrier signal to generate a modulated signal, and drive the plurality of touch sensors using the modulated signal to wirelessly transmit the authentication signal request. The controller may scan the plurality of touch sensors to receive the wireless response signal, determine whether the wireless response signal includes an acknowledgement from the user device, and cause a user key request to be wirelessly transmitted by one or more of the plurality of touch sensors. The controller may scan the plurality of touch sensors for a user key response, determine whether the user key response is valid, and authenticate the user based on determining that the user key response is valid. The controller may cause the plurality of touch sensors to wirelessly transmit an authentication signal to the user device. The controller may scan the plurality of touch sensors for a user key response, determine whether the user key response is valid, and decline to authenticate the user based on determining that the user key response is invalid. The controller may cause the plurality of touch sensors to wirelessly transmit a negative authentication signal to the user device. The controller may modulate data corresponding to the user key request over a carrier signal to generate a modulated signal, and drive the plurality of touch sensors using the modulated signal to wirelessly transmit the user key request. The controller may demodulate the wireless response signal to extract data from the wireless response signal, and wherein the controller is to determine whether the wireless response signal includes an acknowledgement from the user device based on the extracted data.

According to an aspect of one or more examples, there is provided a user authentication system. The user authentication system may include a plurality of touch sensors to detect a touch event and generate one or more touch signals corresponding to the touch event, and a controller configured to receive the one or more touch signals generated by the plurality of touch sensors, generate an authentication request signal in response to the one or more touch signals, transmit the authentication request signal to one or more of the plurality of touch sensors for transmission through a conductive medium to a user device, receive a response signal from the user device via the conductive medium through one or more of the plurality of touch sensors, and evaluate the response signal from the user device to determine an authentication status of a user. The plurality of touch sensors may be configured to transmit the authentication request signal received from the controller through the conductive medium to the user device, and receive the response signal from the user device via the conductive medium and transmit the response signal to the controller.

The response signal from the user device may include authentication credentials that match stored valid credentials. The controller may authenticate the user based on successfully verifying the authentication credentials in the response signal. The response signal from the user device may include a negative acknowledgement. The controller may deny authentication based on the negative acknowledgement in the response signal automatically triggering an unsuccessful verification. The response signal from the user device may include authentication credentials that do not match stored valid credentials. The controller may deny authentication based on the authentication credentials in the response signal failing verification. The user device may fail to transmit a response signal within a predetermined time period after receiving the authentication request signal, and the controller may deny authentication based on non-receipt of the response signal within the predetermined time period. The controller may scan the plurality of touch sensors to receive the one or more touch signals, and demodulate the one or more touch signals to extract data from the one or more touch signals. The controller may be configured to modulate data corresponding to the authentication request signal over a carrier signal with a selected frequency to generate a modulated signal. The conductive medium may include organic living material, and the plurality of touch sensors may be configured to establish capacitive coupling with the organic living material to transmit the authentication request signal and receive the response signal from the user device. The user device may include an electronic device configured to be worn or carried by the user, and the user device may be in proximity to the conductive material.

According to one or more examples, there is provided a user authentication method that may include receiving one or more touch signals generated by a plurality of touch sensors, generating an authentication request signal in response to the one or more touch signals, transmitting the authentication request signal to one or more of the plurality of touch sensors for transmission through a conductive medium to a user device, receiving a response signal from the user device via the conductive medium through one or more of the plurality of touch sensors, and evaluating the response signal from the user device to determine an authentication status of a user. The one or more of the plurality of touch sensors may be configured to transmit the authentication request signal received from the controller through the conductive medium to the user device, and receive the response signal from the user device via the conductive medium and transmit the response signal to the controller.

### BRIEF DESCRIPTION OF DRAWINGS

FIG. 1 shows a schematic of a user authentication system 100 according to various examples.

FIG. 2 shows a schematic of a user authentication uploading and downloading data according to various examples.

FIG. 3 shows a flowchart of a user authentication process according to various examples.

FIGS. 4A-4C show data transmissions between a user device and a controller of a user authentication system according to various examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Capacitive touch sensors are mainly used as a human-computer interface for detection of touch events and estimating the touch proximity and location. Touch detection is done by coupling touch sensors to a controller that works to drive sensors, such as charge capacitors, and sense their charge. User authentication is typically done using biometrics, such as a fingerprint, or wireless protocols that enable data communication like Bluetooth, RFID, and WiFi. However, for systems that do not support wireless protocols, there is a need to provide user authentications via alternative methods. For systems that support wireless protocols for user authentication, and include touch sensors, such systems rely on multiple controllers to facilitate these functions, which increases costs, power consumption, and manufacturing complexity. Therefore, there is a need for a system that can provide both touch sensors and user authentication at lower costs, lower power consumption, and reduced manufacturing complexity.

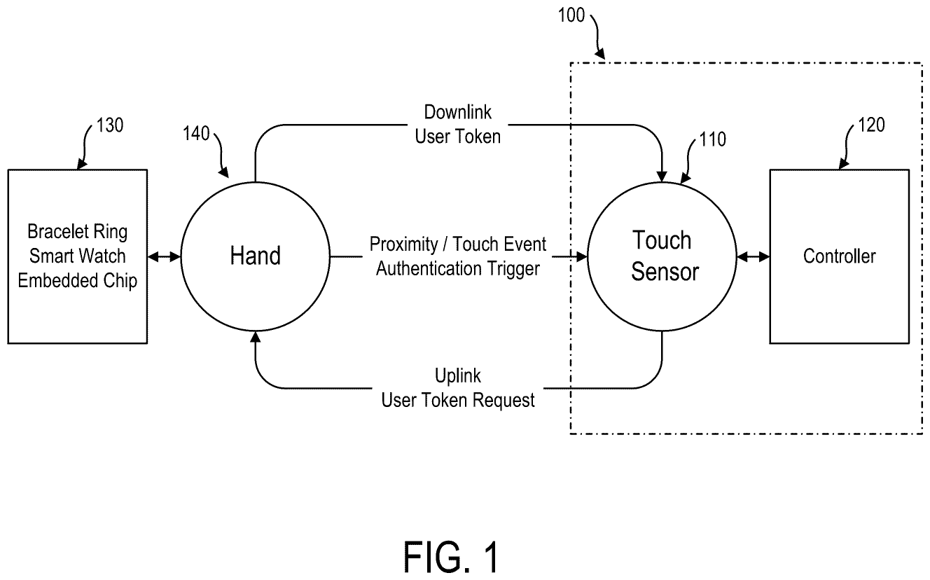

FIG. 1 shows a schematic of a user authentication system 100 according to various examples. As shown in FIG. 1, the user authentication system may include a touch sensor 110, which may include a plurality of touch sensors, and a controller 120. According to various examples, the touch sensor 110 may be an array or grid of capacitive touch sensors, such as in a touch screen display. The touch sensor 110 may be made of Indium Tin Oxide (ITO) material, or other conductive material. The touch sensor 110 and controller 120 may be configured to communicate with a user device 130 that may be worn on the hand 140 of a user. For example, user device 130 may include, without limitation, a smart bracelet, ring, or watch having an imbedded chip. The touch sensor 110 may function as an antenna, and may be coupled to the controller 120 to transmit data received from the controller 120 to the user device 130. According to various examples, the controller 120 may drive the touch sensor 110 with a data modulated signal that may travel from the touch sensor 110 through the user's hand 140 to the user device 130. As described in more detail below, the user device 130 may transmit response signals that may propagate through the user's hand 140 to the touch sensor 110, where the controller 120 can detect and read the response signals.

For example, as shown in FIG. 1 and explained further below, the user's hand 140 may touch or come in close proximity to the touch sensor 110, which may trigger an authentication process. The touch sensor 110, controller 120, or a combination of the two, may detect the touch or proximity event, and may generate an authentication request signal, which according to various examples may be a user token request. The authentication request signal may propagate from the touch sensor through the user's hand 140 to the user device 130. The user device 130 may transmit a wireless response signal that propagates through the user's hand 140 to the touch sensor 110, where it can be detected and read by the controller 120. For example, the wireless response signal may include a user token that identifies the user.

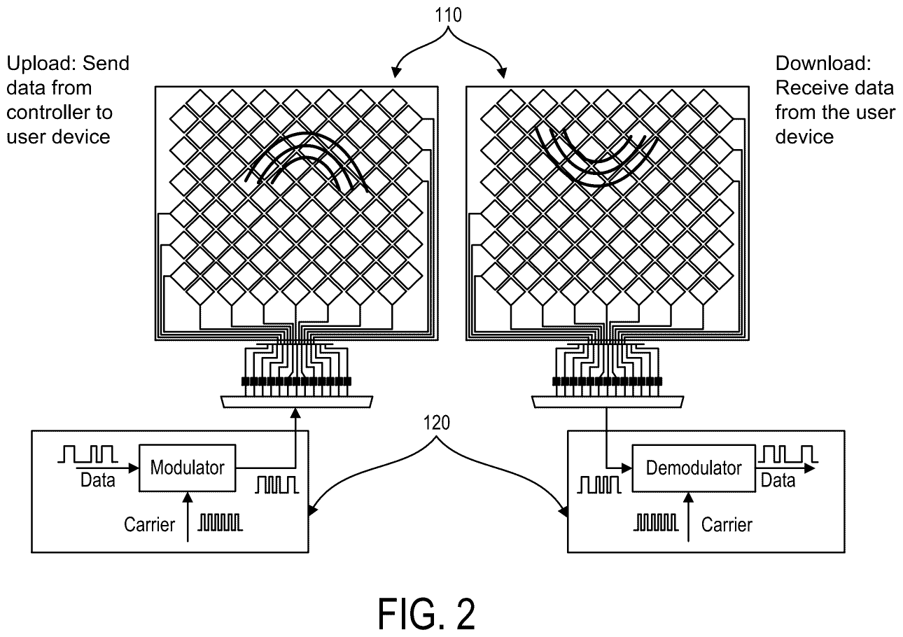

FIG. 2 shows a schematic of a user authentication uploading and downloading data according to various examples. The left side of FIG. 2 shows a schematic of the controller 120 transmitting or uploading data, such as an authentication request signal, to the user device 130 via touch sensor 110 according to various examples. The right side of FIG. 2 shows a schematic of the controller 120 receiving or downloading data from the user device 130 via touch sensor 110 according to various examples. Referring first to the upload function represented on the left side of FIG. 2, the controller 120 may modulate data, such as data corresponding to an authentication request signal, using a carrier signal to be uploaded to the user device 130. Touch sensor 110 may include a plurality of touch sensors, as shown in FIG. 2, which may be driven by controller 120 using the modulated signal. The modulated signal may be transmitted by the touch sensor 110 so that it propagates through the user's hand 140 and is received, demodulated, and processed by the user device 130.

The user device 130 may download data, for example a response to an authentication request signal, to the controller 120 via the touch sensor 110. Referring to the download function represented on the rights side of FIG. 2, a modulated signal that includes data transmitted from the user device 130 may be propagated via the user's hand 140 to the plurality of touch sensors 110. The controller 120 may scan the touch sensor 110 to detect signals received by the touch sensor 110. Upon receiving the modulated signal that was transmitted by the user device 130, the controller 120 may demodulate the modulated signal, and extract data from the modulated signal. The controller 120 may complete the authorization function based on the data extracted from the modulated signal, as described further below.

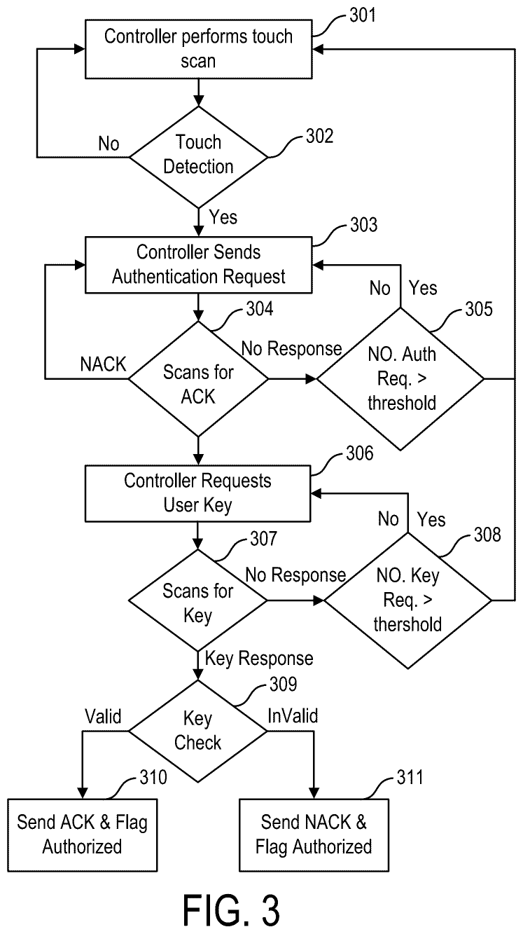

FIG. 3 shows a flowchart of a user authentication process according to various examples. In operation 301, the controller 120 may perform a touch scan of the touch sensor (or plurality of touch sensors) 110. In operation 302, the controller 120 may determine whether a touch of the touch sensor 110 has been detected. If no touch has been detected, the process returns to operation 301 to continue scanning the touch sensor 110. If a touch is detected at operation 302, the process proceeds to operation 303, in which the controller 120 sends an authentication request signal to the user device 130 by generating a modulated signal and driving the touch sensor 110 using the modulated signal, as described above. According to various examples, the controller 120 may drive all of the plurality of touch sensors 110 simultaneously in operation 304 to increase signal strength.

In operation 304, the controller 120 scans the touch sensor 110 for a wireless response signal, such as an acknowledgement signal. If the controller 120 receives a negative acknowledgment signal (NACK) in operation 304, the process returns to operation 303 to send another authentication request signal. If no response is received at operation 304, the process proceeds to operation 305, in which the controller 120 determines whether the amount of time that has elapsed with no response exceeds a threshold. If the amount of time that has elapsed with no response exceeds the threshold, the process returns to operation 301 to scan the touch sensor 110 for touch data. If the amount of time that has elapsed with no response does not exceed the threshold in operation 305, the process returns to operation 303 and the controller 120 sends another authentication request signal.

If a response signal, such as an acknowledgment signal, is received in operation 304, the process continues to operation 306, in which the controller transmits a user key request to the user device 130. For example, the controller 120 may modulate data corresponding to the user key request on a carrier signal, and drive the touch sensors 110 using the modulated signal in order to transmit the user key request to the user device 130 via the user's hand 140. At operation 307, the controller 120 scans the touch sensor 110 to determine if a response signal, such as a user key transmitted from the user device 130, has been transmitted via the user's hand 140 to the touch sensor 110. If no response signal has been received, the process proceeds to operation 308, where the controller 120 determines whether the whether the amount of time that has elapsed with no response exceeds a threshold. If the amount of time that has elapsed with no response exceeds the threshold, the process returns to operation 306 to scan the touch sensor 110 for a response signal.

If it is determined in operation 307 that the user key has been received, the process continues to operation 309, in which the controller 120 determines whether the received user key is valid. If the controller 120 determines that the user key is valid, the process proceeds to operation 310, in which the controller 120 causes an acknowledgement signal (ACK) to be transmitted to the user device 130 and the user is authorized. If the controller 120 determines that the user key is invalid, the process proceeds to operation 311, in which the controller 120 causes a negative acknowledgment (NACK) to be transmitted to the user device 130 and the user is not authorized.

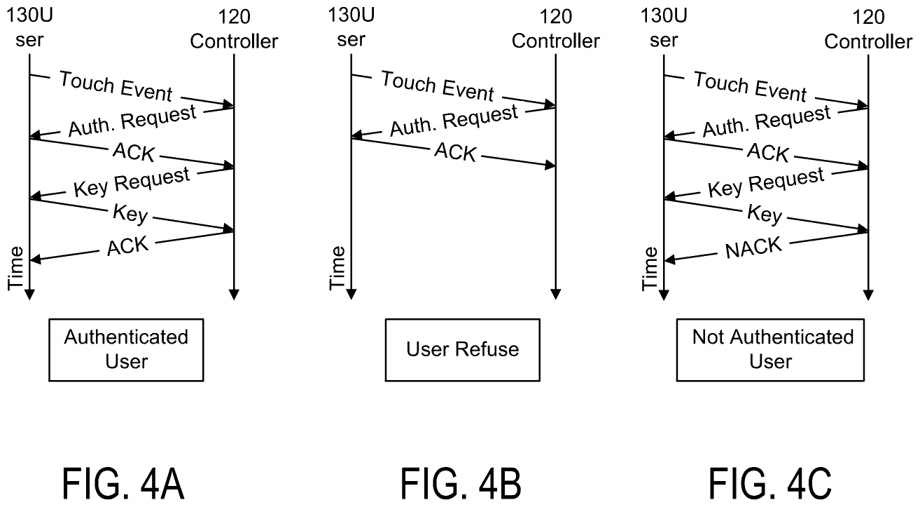

FIGS. 4A-4C show data transmissions between a user device and a controller of a user authentication system according to various examples. In FIG. 4A, data transmissions are shown during an authorization process in which the user is authenticated. In FIG. 4B, data transmissions are shown during an authorization process in which the user refuses authentication. In FIG. 4C, data transmissions are shown during an authorization process in which the user is not authenticated. Referring to FIG. 4A, the authentication process begins with a touch event that is detected by the controller 120 via the touch sensor 110. In response to the touch event, the controller 120 transmits an authentication request to the user device 130. The user device 130 then transmits and acknowledgment signal (ACK) back to the controller 120. In response, the controller 120 transmits a key request signal to the user device 130. The user device 130 responds by transmitting a user key to the controller 120. The controller 120 determines whether the received user key is valid, and if the user key is determined to be valid, the controller transmits an acknowledgment signal (ACK) to the user device 130 to authenticate the user.

Referring to FIG. 4C, the process is identical to the process described in FIG. 4A, except that if the controller 120 determines that the user key received from the user device 130 is not valid, the controller 120 transmits a negative acknowledgment signal (NACK) to the user device 130.

Referring to FIG. 4B, the process begins with a touch event that is detected by the controller 120, and an authentication request signal transmitted by the controller 120 to the user device 130, as in FIGS. 4A and 4C. However, if the user or the user device 130 does not wish to complete the authentication process, the user device 130 may transmit a negative acknowledgment signal (NACK) to the controller 120, which ends the authentication process.

Various examples have been disclosed herein, in connection with the above description and the drawings. It will be understood that it would be unduly repetitious to literally describe and illustrate every combination and subcombination of these examples. Accordingly, all examples can be combined in any way or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A user authentication system comprising:
a plurality of touch sensors to detect a touch event and generate one or more touch signals corresponding to the touch event; and
a controller to receive the one or more touch signals generated by the plurality of touch sensors and generate an authentication request signal in response to the one or more touch signals,
wherein one or more of the plurality of touch sensors are to wirelessly transmit the authentication request signal to a user device and receive a wireless response signal from the user device, and
wherein the controller is to authenticate a user based on the wireless response signal from the user device.

2. The user authentication system of claim 1, wherein the controller is to scan the plurality of touch sensors to receive the one or more touch signals, and demodulate the one or more touch signals to extract data from the one or more touch signals.

3. The user authentication system of claim 1, wherein the controller is to modulate data corresponding to the authentication request signal over a carrier signal to generate a modulated signal, and drive the plurality of touch sensors using the modulated signal to wirelessly transmit the authentication signal request.

4. The user authentication system of claim 1, wherein the controller is to:
scan the plurality of touch sensors to receive the wireless response signal;
determine whether the wireless response signal includes an acknowledgement from the user device; and
cause a user key request to be wirelessly transmitted by one or more of the plurality of touch sensors.

5. The user authentication system of claim 4, wherein the controller is to scan the plurality of touch sensors for a user key response, determine whether the user key response is valid, and authenticate the user based on determining that the user key response is valid.

6. The user authentication system of claim 5, wherein the controller is to cause the plurality of touch sensors to wirelessly transmit an authentication signal to the user device.

7. The user authentication system of claim 4, wherein the controller is to scan the plurality of touch sensors for a user key response, determine whether the user key response is valid, and decline to authenticate the user based on determining that the user key response is invalid.

8. The user authentication system of claim 7, wherein the controller is to cause the plurality of touch sensors to wirelessly transmit a negative authentication signal to the user device.

9. The user authentication system of claim 4, wherein the controller is to modulate data corresponding to the user key request over a carrier signal to generate a modulated signal, and drive the plurality of touch sensors using the modulated signal to wirelessly transmit the user key request.

10. The user authentication system of claim 4, wherein the controller is to demodulate the wireless response signal to extract data from the wireless response signal, and wherein the controller is to determine whether the wireless response signal includes an acknowledgement from the user device based on the extracted data.

11. A user authentication system comprising:
a plurality of touch sensors to detect a touch event and generate one or more touch signals corresponding to the touch event; and
a controller configured to:
receive the one or more touch signals generated by the plurality of touch sensors,
generate an authentication request signal in response to the one or more touch signals;
transmit the authentication request signal to one or more of the plurality of touch sensors for transmission through a conductive medium to a user device,
receive a response signal from the user device via the conductive medium through one or more of the plurality of touch sensors; and
evaluate the response signal from the user device to determine an authentication status of a user,
wherein the plurality of touch sensors are configured to:
transmit the authentication request signal received from the controller through the conductive medium to the user device, and
receive the response signal from the user device via the conductive medium and transmit the response signal to the controller.

12. The user authentication system of claim 11, wherein the response signal from the user device comprises authentication credentials that match stored valid credentials, and wherein the controller authenticates the user based on successfully verifying the authentication credentials in the response signal.

13. The user authentication system of claim 11, wherein the response signal from the user device comprises a negative acknowledgement, and wherein the controller denies authentication based on the negative acknowledgement in the response signal automatically triggering an unsuccessful verification.

14. The user authentication system of claim 11, wherein the response signal from the user device comprises authentication credentials that do not match stored valid credentials, and wherein the controller denies authentication based on the authentication credentials in the response signal failing verification.

15. The user authentication system of claim 11, wherein the user device fails to transmit a response signal within a predetermined time period after receiving the authentication request signal, and wherein the controller denies authentication based on non-receipt of the response signal within the predetermined time period.

16. The user authentication system of claim 11, wherein the controller is to scan the plurality of touch sensors to receive the one or more touch signals, and demodulate the one or more touch signals to extract data from the one or more touch signals.

17. The user authentication system of claim 11, wherein the controller is configured to modulate data corresponding to the authentication request signal over a carrier signal with a selected frequency to generate a modulated signal.

18. The user authentication system of claim 11, wherein the conductive medium comprises organic living material, and wherein the plurality of touch sensors are configured to establish capacitive coupling with the organic living material to transmit the authentication request signal and receive the response signal from the user device.

19. The user authentication system of claim 11, wherein the user device comprises an electronic device configured to be worn or carried by the user, and wherein the user device is in proximity to the conductive material.

20. A user authentication method comprising:
receiving one or more touch signals generated by a plurality of touch sensors,
generating an authentication request signal in response to the one or more touch signals;
transmitting the authentication request signal to one or more of the plurality of touch sensors for transmission through a conductive medium to a user device,
receiving a response signal from the user device via the conductive medium through one or more of the plurality of touch sensors; and
evaluating the response signal from the user device to determine an authentication status of a user;
wherein the one or more of the plurality of touch sensors are configured to:
transmit the authentication request signal received from the controller through the conductive medium to the user device; and
receive the response signal from the user device via the conductive medium and transmit the response signal to the controller.
